(19) United States
(12) Patent Application Publication
(10) Pub. No.: US 2007/0035366 A1
(43) Pub. Date: Feb. 15, 2007

(54) Method and circuit arrangement for rapidly switching off low-voltage circuit breakers

(75) Inventors: Clifford A. Buxton, Bellefontaine, OH (US); Marc Liebetruth, Glienicke (DE); Wolfgang Röhl, Berlin (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, München (DE)

(21) Appl. No.: 10/571,563

(22) PCT Filed: Aug. 16, 2004
(86) PCT No.: PCT/DE04/01842

§ 371 Date: Mar. 10, 2006

(30) Foreign Application Priority Data
Sep. 11, 2003 (DE) 103 42 598.5

(51) Int. Cl. H01H 75/00

(52) U.S. Cl. 335/14

(57) ABSTRACT

A method and a circuit arrangement are disclosed for rapidly switching off low-voltage circuit breakers by impinging a switching element which is operated in a short-circuit mode during normal operation and to which a fast trip magnet is connected in parallel, with a current that is proportionate to the current monitored by the low-voltage circuit breaker while the short circuit of the switching element is bypassed when the current monitored by the low-voltage circuit breaker reaches a set threshold value. The fast trip magnet is at least temporarily short-circuited once again as soon as the monitored current reaches a second given threshold value. A corresponding circuit can be designed such that the switching element is embodied as a switching transistor which can be controlled back into the conducting state by a second monitoring circuit for the current monitored by the low-voltage circuit breaker when a second given threshold value has been reached.

### DESCRIPTION

Method and circuit arrangement for rapidly tripping low-voltage power breakers

The invention relates to a method and a circuit arrangement for rapidly tripping low-voltage power breakers by a switching element, which is operated in the short circuit during normal operation and which is connected in parallel with a rapid-response tripping magnet of the low-voltage power breaker, having a current applied to it which is proportional to the current monitored by the low-voltage power breaker, and the short circuit across this switching element being canceled if the current monitored by the low-voltage power breaker reaches a fixed threshold value.

At high currents, for example owing to a short circuit in the power supply system, even undelayed tripping of a low-voltage power breaker may be still be too slow since the signal processing in the microprocessor of the electronic release requires a certain amount of time. In the case of low-voltage power breakers in which the power for the tripping unit is drawn from the power supply system itself via further current transformers and rectifiers, when the power breaker is first used there is also not yet any power available for as long as an associated charging capacitor has not yet been charged. It has therefore already been proposed, in the event that a high current is detected in the power supply system, to allow this high current to commutate directly onto a rapid-response tripping magnet of the power breaker, which causes the switch to latch. For this purpose, the secondary sides of the current transformers provided for the supply of power to the tripping unit are connected to the tripping unit via bridge rectifiers and via a short-circuit path of a switching element. The rapid-response tripping magnet is connected in parallel with the switching element, for example a reed relay, a transistor, driven from a uniform-field coil, a field sensor or the like, and is short-circuited during normal operation. Only at high short-circuit currents in the power supply system, for example 35 kA, does the parallel short-circuit path open such that the rapid-response tripping magnet is activated.

However, at very high currents the tripping magnet may under certain circumstances be subjected to a high thermal load, which may lead to it being damaged or even to failure of the power breaker. If the tripping magnet contains a permanent-magnet core, as is usual, the following effects may also occur: if the tripping magnet has a current applied to it which is too high, the permanent magnet may remagnetize and its tripping time increases or, in the most unfavorable case, no tripping takes place at all. In all cases, the rapid “application” of a strong magnetic field opposing that of the permanent magnet is responsible for this effect. It has been shown that, at a specific current, there is an optimum as regards the tripping speed.

The invention is based on the object of specifying a circuit arrangement for rapidly tripping low-voltage power breakers which brings about reliable tripping even at high currents and does not endanger the tripping magnet in the process.

The object is achieved according to the invention by the features of claims 1 and 2. Expedient refinements are the subject matter of the dependent claims.

Accordingly, the rapid-response tripping magnet is short-circuited again at least temporarily as soon as the monitored current reaches a second predetermined threshold value.

An associated circuit arrangement for implementing the method can be designed such that the switching element is a switching transistor which can be controlled, by means of a second monitoring circuit for the current monitored by the low-voltage power breaker, so as to return to the on state when a second predetermined threshold value is reached.

In addition to the previously known measures, the method or the circuit arrangement ensures that the current through the magnet cannot rise any further once a predetermined value has been reached. This achieves the following advantages:
a) It is not possible for the magnet to be subjected to a thermal overload.
b) It is not possible for a permanent magnet of the release to be changed in any way.
c) An unchanged rapid response of the magnet is ensured.
d) Failure to trip is not possible at high input currents.

Driving can take place from the current transformers, for which a standard type is provided, with the result that no notable current limiting occurs in the upper current range. This means that the method is preferably implemented with dedicated current transformers for the rapid tripping. Intervention in the power supply for the electronic tripping unit, as is known from the exemplary solution, is thus not necessary. Firstly, this has the advantage that rapid tripping can also be carried out retrospectively. Secondly, not all of the switches need to be designed to have the option for rapid tripping, since only a few system operators require this function.

As in the case of the previously known circuit for rapidly tripping a low-voltage power breaker, the measure has the advantage that tripping takes place very rapidly in the event of a short circuit in the monitored system and even takes place when the power breaker switches to a short circuit on connection.

The invention will be explained in more detail by way of example below with reference to the drawings, in which:

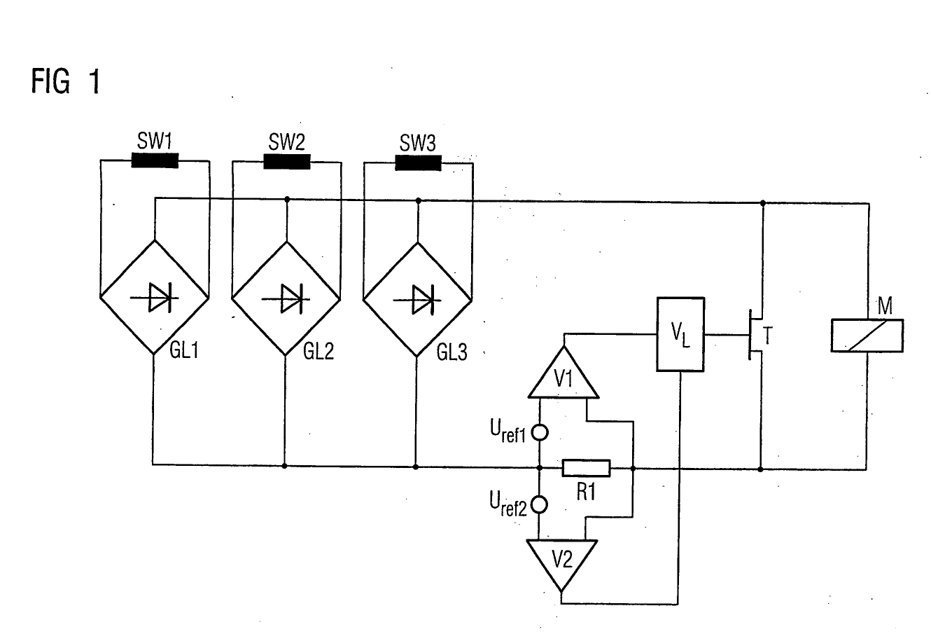

FIG. 1 shows one example of a circuit arrangement according to the invention, and

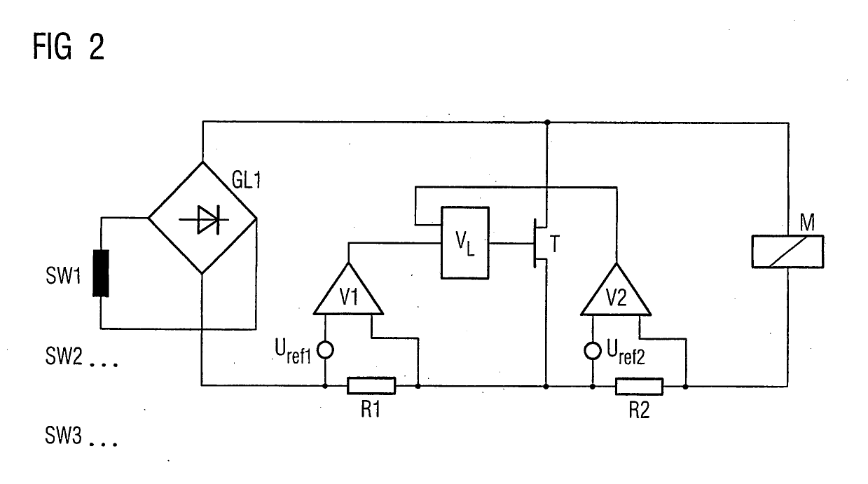

FIG. 2 shows a second variant of the circuit arrangement.

FIG. 1 shows a schematic of an electronic release for a low-voltage power breaker on a three-phase power supply system. The secondary sides of current transformers SW1, SW2, SW3 are connected in parallel via bridge rectifiers GL1, GL2, GL3. In the current path of this tripping circuit there is a switching transistor T, which is controlled by a drive circuit VL so as to be in the on mode during normal operation. Connected in parallel with the transistor T is a rapid-response tripping magnet M of the low-voltage power breaker. The tripping magnet M is thus normally short-circuited by the switching transistor T.

The drive circuit VL can be driven by the output of a comparator V1, whose inputs are bridged by a reference voltage source Uref1 and a resistor R1, which is in the current path of the tripping circuit.

If the voltage across the resistor R1 exceeds a response value predetermined by the reference voltage source Uref1, the switching transistor T previously operated in the short circuit is opened and the current commutates to the tripping magnet M, which brings about the rapid tripping of the low-voltage power breaker. Thus far the principle of rapid tripping is already known.

The invention now provides a further comparator V2 and a second reference voltage source Uref2, which act in a comparable manner to the comparator V1. If the voltage across the resistor R1 exceeds a value predetermined by the reference voltage source Uref2 as a result of a correspondingly high current, the switching transistor T is switched back to the current-conducting mode via the comparator V2 and the second input at the drive circuit VL.

The above-described circuit also has the disadvantage that, in the event of a very steep current rise, under certain circumstances the drive pulse to the tripping magnet M is too short. The circuit shown in FIG. 2 avoids this disadvantage by the second comparator V2 with a second resistor R2 being connected into the circuit of the magnet M. Since in this case the current through the tripping magnet M is regulated in a clocked manner, no time-critical effects occur. The clocking takes place automatically as long as the current across the resistor R2 produces a voltage which is greater than the reference voltage Uref1. As soon as the voltage across the resistor R2 exceeds the reference voltage Uref2, the current commutates to the transistor T. If it falls below this value again, the current commutates back to the magnet M.

1. A method for rapidly tripping low-voltage power circuit breakers by a switching element, operated in a short circuit during normal operation and connected in parallel with a rapid-response tripping magnetic of the low-voltage power circuit breaker, the method comprising:
applying a current to the switching element which is proportional to the current monitored by the low-voltage power circuit breaker, the short circuit across the switching element being canceled if the current monitored by the low-voltage power circuit breaker reaches a fixed threshold value; and
short-circuiting the rapid-response tripping magnet again, at least temporarily, as soon as the monitored current reaches a second predetermined threshold value.

2. A circuit arrangement for rapidly tripping a low-voltage power circuit breaker, comprising:
a switching element, operated in the short circuit during normal operation and connected in parallel with a rapid-response tripping magnet of the low-voltage power circuit breaker, current applied to the switching element being proportional to the current monitored by the low-voltage power circuit breaker; and
a monitoring circuit for the current monitored by the low-voltage breaker, the monitoring circuit being used to cancel the short circuit across the switching element when a fixed threshold value is reached, the switching element being a switching transistor controllable by a second monitoring circuit for the current monitored by the low-voltage power circuit breaker, so as to return to the on state when a second predetermined threshold value is reached.

3. The circuit arrangement as claimed in claim 2,
wherein at least one of the monitoring circuits includes a comparator, a reference voltage source and a voltage which is proportional to the current in the tripping circuit being applied to the inputs of said comparator, and the output of the comparator being passed to a drive circuit controlling the switching transistor.

4. The circuit arrangement as claimed in claim 2,
wherein least one of the monitoring circuits includes a comparator, a reference voltage source and a voltage which is proportional to the current in the circuit of the tripping magnet being applied to the inputs of said comparator, and the output of the comparator being passed to a drive circuit controlling the switching transistor.

5. A circuit arrangement for rapidly tripping a low-voltage power circuit breaker, comprising:
a switching element, operated in the short circuit during normal operation and connected in parallel with a rapid-response tripping magnet of the low-voltage power circuit breaker, a current applied to the switching element being proportional to the current monitored by the low-voltage power circuit breaker; and
means for canceling the short circuit across the switching element when a fixed threshold value is reached, and for returning the switching element to the on state when a second predetermined threshold value is reached.

6. A method for rapidly tripping low-voltage power circuit breakers by a switching element, operated in a short circuit during normal operation and connected in parallel with a rapid-response tripping magnetic of the low-voltage power circuit breaker, a current applied to the switching element being proportional to the current monitored by the low-voltage power circuit breaker, the method comprising:
canceling the short circuit across the switching element when a fixed threshold value is reached; and
returning the switching element to the on state when a second predetermined threshold value is reached.
